(19) United States
(12) Patent Application Publication
(10) Pub. No.: US 2014/0270576 A1
(43) Pub. Date: Sep. 18, 2014

(54) OVENABLE BAG CONVERTIBLE INTO A BAKING SHEET

(71) Applicant: H.J. HEINZ COMPANY, Pittsburgh, PA (US)

(72) Inventor: John Gerard RYAN, Dundalk (IE)

(73) Assignee: H.J. HEINZ COMPANY, Pittsburgh, PA (US)

(21) Appl. No.: 13/828,447

(22) Filed: Mar. 14, 2013

(51) Int. Cl. B65D 30/00; B31B 41/00; B31B 29/00; B65D 30/08; B65D 30/10

(52) U.S. Cl. CPC B65D 31/005; B65D 31/04; B65D 31/16; B31B 29/00; B31B 41/00
USPC 383/4; 493/243; 493/264; 383/104; 383/122

(57) ABSTRACT

An ovenable bag that is convertible into a baking sheet for baking a food product is provided. The ovenable bag may include a front panel, a rear panel, and a closure disposed on the front panel. The front panel and the rear panel define an interior chamber for holding the food product, and the closure is configured to allow the ovenable bag to be openable into the baking sheet. A related ovenable blank and method of forming an ovenable bag are also provided.

### BACKGROUND OF THE INVENTION

1. Field of the Invention

This disclosure relates to food packaging and more particularly to food packaging having consumer oriented diverse utility for baking a food product.

2. Background

In an ever-increasingly time demanding society, busy individuals and families struggle to find time for preparing traditional meals that require planning, a multitude of ingredients, a variety of utensils and time. Therefore, these individuals and families rely on pre-packaged “prepared” meals to eliminate the preparation time associated with traditional meals and get them more quickly to their next work, school or social commitment. While microwavable packages have been developed to save time and satisfy on-the-go consumers' palates, there is a need for providing these consumers with time-saving and convenient baking options as well.

### SUMMARY OF THE INVENTION

Accordingly, the present disclosure overcomes the drawbacks associated with existing time-saving, food packaging options by providing a convenient, time-saving ovenable package for storing and baking a food product. The convertible ovenable bag enhances time-savings and food options available to busy consumers by simplifying preparation and clean-up for baking the food product and reducing clean-up time.

In this regard and according to a non-limiting embodiment of the present disclosure, an ovenable bag convertible into a baking sheet for baking a food product is provided.

According to a non-limiting embodiment of the present disclosure, the ovenable bag may include a front panel, a rear panel, and a closure disposed on the front panel where the front panel and the rear panel define an interior chamber for holding the food product, and the closure is configured to allow the ovenable bag to be openable into the baking sheet.

According to another non-limiting embodiment of the present disclosure, the ovenable bag may include opposing sealed edge portions and opposing folded edge portions extending in a direction generally transverse to the opposing sealed edge portions where the sealed edge portions and the folded edge portions define outer edge portions of the ovenable bag. The ovenable bag may be structured in this manner so that when the closure is opened, the sealed edge portions may separate and the folded edge portions unfold such that the ovenable bag is openable into the baking sheet.

According to yet another non-limiting embodiment of the present disclosure, the closure may include a sealed closure flap that extends along a longitudinal length of the front panel, and the sealed closure flap and the sealed edge portions may be sealed with a peelable adhesive.

According to still another non-limiting embodiment of the present disclosure, the closure may extend in the direction generally transverse to the opposing sealed edge portions along an entire longitudinal length of the front panel.

According to a non-limiting embodiment of the present disclosure, the ovenable bag may include a gripping region disposed on the front panel and proximate opposing sides of the closure, and the gripping region may be configured to allow external forces to act on opposing sides of the closure to open the closure and allow the ovenable bag to be openable into the baking sheet.

According to another non-limiting embodiment of the present disclosure, the front panel and the rear panel may each include a plurality of material layers. The plurality of material layers may include at least a paper layer laminated to a polymer layer where the polymer layer defines an inner surface of the bag that forms the interior chamber and an upper baking surface of the baking sheet when the ovenable bag is opened into the baking sheet, and the paper layer defines an outer surface of the ovenable bag and a lower baking surface of the baking sheet when the ovenable bag is opened into the baking sheet.

According to yet another non-limiting embodiment of the present disclosure, the paper layer may be a printable virgin fiber paper and the polymer layer may be a nylon, and a thickness ratio of the paper layer to the polymer layer may be 3:1.

According to still another non-limiting embodiment of the present disclosure, the plurality of layers is devoid of any metallic element or microwave susceptor element.

According to a non-limiting embodiment of the present disclosure, an ovenable blank for forming an ovenable bag that is convertible into a baking sheet for baking a food product may be provided. The ovenable blank may include a first panel including a first side edge, a second side edge, an upper edge portion and a bottom edge portion, a second panel including an outer side edge, an inner side edge, an upper edge portion and a bottom edge portion, the inner side edge of the second panel being disposed along the first side edge of the first panel at a first fold line, a third panel including an outer edge, inner side edge, an upper edge portion and a bottom edge portion, the inner side edge of the third panel being disposed along the second side edge of the first panel at a second fold line, a fourth panel including an outer side edge, an inner side edge, an upper edge portion and a bottom edge portion, the inner side edge of the fourth panel being disposed along the outer side edge of the second panel at a third fold line, and a fifth panel including an outer side edge, inner side edge, an upper edge portion and a bottom edge portion, the inner side edge of the fifth panel being disposed along the outer side edge of the third panel at a fourth fold line. Each of the upper edge portion and the bottom edge portion of at least one of either the first panel, or the second and third panels together, may be coated with a peelable adhesive on a top side surface of the blank, and at least one of the fourth panel and the fifth panel may be entirely coated with the peelable adhesive on the top side surface of the blank.

According to another non-limiting embodiment of the present disclosure, the upper edge portion and the bottom edge portion of each of the first, second, and third panels may be coated with the peelable adhesive on the top side surface of the blank, and each of the fourth panel and the fifth panel may be entirely coated with the peelable adhesive on the top side surface of the blank.

According to yet another non-limiting embodiment of the present disclosure, the second and third panels may be configured to fold over the first and second fold lines, respectively, to cover the first panel and to define an interior chamber for holding the food product. When the second and third panels are folded over the first panel, the first fold line and the second fold line may define folded edge portions of the ovenable bag, the upper edge portion and the bottom edge portion of each of the second panel and the third panel may be adhesively secured to the upper edge portion and the bottom edge portion of the first panel to define sealed edge portions of the ovenable bag, and the fourth and fifth panels may be adhesively secured to one another to define a sealed closure flap disposed on the front panel of the ovenable bag. The sealed closure flap may be foldable over one of the third and fourth fold lines in a direction toward one of the second and third panels, respectively.

According to still another non-limiting embodiment of the present disclosure, top side surfaces of the second and third panels may be configured to fold over the first and second fold lines, respectively, to cover a top side surface of first panel to define an interior chamber for holding the food product, and when the second and third panels are folded over the first panel, bottom side surfaces of the second and third panels may define a front panel of the ovenable bag and a bottom side surface of the first panel may define a rear panel of the ovenable bag.

According to a non-limiting embodiment of the present disclosure, the ovenable blank may include a plurality of material layers. The plurality of material layers may include at least a paper layer laminated to a polymer layer, where the polymer layer defines the top side surface of the ovenable blank that forms an upper baking surface of the baking sheet and an interior chamber of the ovenable bag and when the second and third panels are folded over the first panel, and where the paper layer defines the bottom side surface of the ovenable blank that forms a lower baking surface of the baking sheet and an outer surface of the ovenable bag when the second and third panels are folded over the first panel.

According to another non-limiting embodiment of the present disclosure, the paper layer of the ovenable blank may be a printable virgin fiber paper and the polymer layer may be a nylon, and a thickness ratio of the paper layer to the polymer layer may be 3:1.

According to yet another non-limiting embodiment of the present disclosure, the plurality of layers of the ovenable blank may be devoid of any metallic element or microwave susceptor element.

According to a non-limiting embodiment of the present disclosure, a method of forming an ovenable bag convertible into a baking sheet for baking a food product may be provided. The method of forming the ovenable bag may include the methods of forming the ovenable bag from a plurality of material layers, placing the food product in the ovenable bag, and sealing the ovenable bag to secure the food product therein. The ovenable bag may include a front panel, a rear panel, and a closure disposed on the front panel. The front panel and the rear panel may define an interior chamber therebetween that holds the food product, and the closure may be configured to allow the ovenable bag to be opened into the baking sheet for placement in an oven environment.

According to another non-limiting embodiment of the present application, the method may include forming the ovenable bag where the ovenable bag includes opposing sealed edge portions and opposing folded edge portions extending in a direction generally transverse to the opposing sealed edge portions. The sealed edge portions and the folded edge portions may define outer edge portions of the ovenable bag such that when the closure is opened, the sealed edge portions may separate and the folded edge portions unfold such that the ovenable bag is openable into the baking sheet.

According to yet another non-limiting embodiment of the present application, the method of forming the ovenable bag with the plurality of material layers may include at least a paper layer laminated to a polymer layer where the polymer layer defines an inner surface of the ovenable bag that forms the interior chamber and an upper baking surface of the baking sheet when the ovenable bag is opened into the baking sheet, and where the paper layer defines an outer surface of the ovenable bag and a lower baking surface of the baking sheet when the ovenable bag is opened into the baking sheet.

According to still another non-limiting embodiment of the present disclosure, the method of forming the ovenable bag with the paper layer and the polymer layer may include a printable virgin fiber paper and a nylon, and a thickness ratio of the paper layer to the polymer layer may be 3:1.

According to another non-limiting embodiment of the present disclosure, the method of forming the ovenable bag may include the plurality of layers devoid of any metallic element or microwave susceptor element.

### BRIEF DESCRIPTION OF THE DRAWINGS

The present disclosure provides a detailed description that follows by reference to the noted drawings by way of non-limiting examples, in which like reference numerals represent similar parts throughout several views of the drawings, and in which:

FIG. 1 is a partial perspective view of an ovenable bag convertible into a baking sheet according to a non-limiting embodiment of the present disclosure;

FIG. 2 is a partial perspective view of a front panel of the ovenable bag shown in FIG. 1;

FIG. 3 is a partial perspective view of a partially opened closure of the ovenable bag shown in FIG. 1.

FIG. 4 is a plan view of a blank for forming an ovenable bag that is convertible into a baking sheet according to a non-limiting embodiment of the present disclosure;

FIG. 5 is a partial perspective view of the blank as shown in FIG. 4; and

FIG. 6 is a cross-sectional illustration of material layers of a blank for forming an ovenable bag that is convertible into a baking sheet according to a non-limiting embodiment of the present disclosure.

### DETAILED DESCRIPTION OF THE EMBODIMENTS

The particulars shown herein are by way of example and for purposes of illustrative discussion of the embodiments of the present invention only and are presented in such a manner so as to provide what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

According to a first non-limiting embodiment of the present disclosure and as shown, for example, in FIGS. 1-3, an ovenable bag (100) is provided. The ovenable bag may be openable or may remain closed to bake a food product. The term ovenable bag may be defined as a bag constructed to be heated in a typical oven environment (e.g., in a conventional baking oven, a convection oven, and a toaster oven) and resistant to structural degradation for the duration of a baking operation. It is contemplated that a typical oven environment usually has a baking range between 200° F. and 500° F. It is also contemplated that the ovenable bag is microwavable and thus may remain closed or be opened to microwave a food product as well.

As shown in FIGS. 1-3 and 5, the ovenable bag (100) is convertible into a baking sheet (110) for baking a food product. The ovenable bag (100) shown in FIG. 1 includes a front panel (120), a rear panel (130), and a closure (140) disposed on the front panel (120) and may be pliable when handled. The ovenable bag (100) may be configured in a variety of bag sizes to accommodate unique consumer demands. For example, the ovenable bag (100) may be configured in a 170 g and 600 g capacity size (although other sizes, depending on consumer demand, are also contemplated). The variety of sizes enables the consumer (for example, busy individual and family consumers) the option of multiple serving size bags for convenience and for portion control. The effective construction also allows for increased storage of the ovenable bag (100) in limited storage spaces. Examples of the food product may include, but are not limited to, fruits, vegetables, meats, chips, potatoes, pizzas, sandwiches and any number of baked goods including, for example, breads, biscuits, cookies, cakes, pastries, and pies.

As shown in FIG. 1 the ovenable bag (100) further includes opposing sealed edge portions (101, 103), and opposing folded edge portions (105, 107) extending in a direction generally transverse to the opposing sealed edge portions (101, 103). The sealed edge portions (101, 103) and the folded edge portions (105, 107) define outer edge portions of the ovenable bag (100). It is noted that the front panel (120) and the rear panel (130) each include sealed edge portions such that the front panel (120) sealed edge portions are adhered to the rear panel (130) sealed edge portions to form the sealed edge portions (101, 103).

As can be seen in FIG. 3, the front panel (120) and the rear panel (130), along with the outer edge portions of the ovenable bag (100), define an interior chamber (125) for holding the food product, and the closure (140) is configured to allow the ovenable bag (100) to be openable into the baking sheet (110).

As shown in FIG. 2, the ovenable bag (100) also includes a gripping region (160) disposed on the front panel (120) and proximate opposing sides (123, 125) of the closure (140). The gripping region (160) is configured to allow external forces acting on the opposing sides (123, 125) of the closure (140) (at front panel (120)) to open the closure (140) and allow the ovenable bag (100) to be openable into the baking sheet (110). For example, a consumer wanting to retrieve the food product disposed in the ovenable bag (100), or convert the ovenable bag (100) into the baking sheet (110) for baking the food product, may grip (or pinch) the opposing sides (123, 125) of the closure (140) and pull the opposing side (123,125) away from one another with a sufficient pulling force so as to open the closure (140). In embodiments, the closure (140) may be peeled and/or torn open from a middle portion of the front panel (120).

As also shown in FIGS. 1 and 2, the closure (140) includes a sealed closure flap (145) that extends along a longitudinal length of the front panel (120), and the sealed closure flap (145) and the sealed edge portions (101, 103) are sealed closed with a peelable adhesive. The sealed closure flap (145) includes end sections of the opposing sides (123,125) of the front panel (120). The end sections of the opposing sides (123, 125) are configured to face each other and be adhered to one another. The end sections may be adhered to one another via the peelable adhesive, although use of conventional interlocking tongue and groove structures (such as a Zip-lock©—type closure) to secure the end sections to each other is also contemplated. The closure (140) also extends in the direction generally transverse to the opposing sealed edge portions (101, 103) along an entire longitudinal length of the front panel (120). This construction increases the gripping region to provide multiple locations to reliably grip and open the sealed closure flap (145). Such a construction also enables the ovenable bag (100) to more easily be unfolded into the baking sheet (110).

In embodiments, the closure (140) may be a tear-strip mechanism where the sealed closure flap (145) includes tear promoting score lines (for example, perforations) extending along the longitudinal length of the front panel (120) at an ovenable bag (100) side of the sealed closure flap (145) (i.e., at a position where the ovenable bag and the sealed closure flap (145) converge) so as to promote tearing of the sealed closure flap (145) from the ovenable bag (100). It is contemplated, however, that the sealed edge portions (101, 103) may be a tear strip mechanism where the tear promoting score lines extend along one or both of the sealed edge portions (101, 103) in addition to the peelable sealed closure flap (145).

During a conversion operation, i.e., when the ovenable bag (100) is converted into the baking sheet (110), and as shown in FIGS. 1-3 and 5, the gripping region (160) is pulled in opposing directions so that the sealed closure flap (145) extending along the longitudinal length of the ovenable bag (100), which includes the end sections of each opposing side (123,125), is separated or peeled away from itself so as to expose the interior chamber (125). Due to the construction of the ovenable bag (100), and as shown in FIG. 3, the sealed closure flap (145) opens from a center section of the ovenable bag (100) and as the opposing sides (123, 125) are pulled away from each another, the sealed closure flap (145) is peeled from the center section along its longitudinal length towards the sealed edge portions (101, 103). As a result, the end sections of each opposing side (123, 125) completely separate from each other in a relatively even manner.

Comparing FIG. 3 and FIG. 5 now, when the opposing sides (123, 125) separate, the sealed edge portions (101, 103) separate (in a direction transverse to the separation direction of the sealed closure flap (145)) and the folded edge portions (105, 107) unfold such that the ovenable bag (100) is openable into the baking sheet (110). The folded edge portions (105,107) also unfold as the sealed edge portions (101, 103) separate from each other, and the sealed edge portions (101, 103) separate from each other in a relatively even manner along sealed edge portion sections of each opposing side (123, 125). Such a construction enables the consumer to easily open the bag while easily and stably retaining the contents of the ovenable bag (100) on a baking surface (the former interior chamber (125)) of the baking sheet (110). This construction also eliminates the need to place the food product on a separate baking sheet and thus reduces food preparation time and simplifies post baking clean-up.

According to a second non-limiting embodiment of the present disclosure and as shown, for example, in FIGS. 4 and 5, the baking sheet (110) may be configured as an ovenable blank (400). The ovenable blank (400) is capable of forming the ovenable bag (100) and being converted into the baking sheet (110).

As illustrated, for example, in FIG. 4, the ovenable blank (400) includes a top side surface (401) and a bottom side surface (403) and may be divided into first (410), second (420), third (430), fourth (440) and fifth (450) panels. The first panel (410) includes a first side edge (412), a second side edge (414), an upper edge portion (416) and a bottom edge portion (418).

The second panel (420) includes an outer side edge (422), an inner side edge (424), an upper edge portion (426) and a bottom edge portion (428). The inner side edge (424) of the second panel (420) is disposed along the first side edge (412) of the first panel (410) at a first fold line (460).

The third panel (430) includes an outer side edge (432), inner side edge (434), an upper edge portion (436) and a bottom edge portion (438). The inner side edge (434) of the third panel (430) is disposed along the second side edge (414) of the first panel (410) at a second fold line (470).

The fourth panel (440) includes an outer side edge (442), an inner side edge (444), an upper edge portion (446) and a bottom edge portion (448). The inner side edge (444) of the fourth panel (440) is disposed along the outer side edge (422) of the second panel at a third fold line (480).

The fifth panel (450) includes an outer side edge (452), inner side edge (454), an upper edge portion (456) and a bottom edge portion (458). The inner side edge (454) of the fifth panel (450) is disposed along the outer side edge (432) of the third panel (430) at a fourth fold line (490).

FIG. 4 also shows that the upper edge portion and the bottom edge portion of each of the first (410), second (420), and third (430) panels are coated with a peelable adhesive (605) (see FIG. 6) on the top side surface (401) of the blank (400), and that each of the fourth panel (440) and the fifth panel (450) is entirely coated with the peelable adhesive (605) on the top side surface (401) of the blank (400).

It is contemplated, however, that not each of the upper and lower edge portions of the ovenable blank (400) and each of the fourth (440) and fifth (450) panels must be coated in the peelable adhesive (605). Instead, only some of the above-noted surfaces may be coated in the peelable adhesive (605). In this regard, in embodiments, only the upper edge portions and the bottom edge portions of at least one of either the first panel (410), or the second (420) and third (430) panels together, may be coated with the peelable adhesive (605) (see FIG. 6) on the top side surface (401) of the blank (400), and that at least one of the fourth panel (440) and the fifth panel (450) is entirely coated with the peelable adhesive (605) on the top side surface (401) of the blank (400).

The second (420) and third (430) panels are configured to fold over the first (460) and second (470) fold lines, respectively, to cover the first panel (410) from the top side thereof and to define the interior chamber (125) of the ovenable bag (100) that holds the food product.

When the second (420) and third (430) panels shown in FIG. 4 are folded over the first panel (410), the first fold line (460) and the second fold line (470) define the folded edge portions (105, 107) of the ovenable bag (100) as shown in FIG. 1. Additionally, the upper edge portion (426, 436) and the bottom edge portion (428, 438) of each of the second panel (420) and the third panel (430) shown in FIG. 4 are adhesively secured to the upper edge portion (416) and the bottom edge portion (418) of the first panel (410) to define the sealed edge portions (101, 103) of the ovenable bag (100) as shown in FIG. 1. Further, top side surfaces of the fourth (440) and fifth (450) panels shown in FIG. 4 are adhesively secured to one another to define the sealed closure flap (145) disposed on the front panel (120) of the ovenable bag (100) as shown in FIGS. 1 and 2. It is noted that the sealed closure flap (145) shown in FIGS. 1 and 2 is foldable over one of the third (480) and fourth (490) fold lines in a direction toward one of the second (420) and third (430) panels, respectively, as shown in FIG. 4.

As also shown, for example, in FIG. 4, top side surfaces (420a, 430a) of the second (420) and third (430) panels are configured to fold over the first (460) and second (470) fold lines, respectively, to cover a top side surface (410a) of first panel (410) to define the interior chamber (125) of the ovenable bag (100) for holding the food product as shown in FIG. 3.

When the second (420) and third (430) panels are folded over the first panel (410), bottom side surfaces (420b, 430b) of the second (420) and third panels (430) define the front panel (120) of the ovenable bag (100) and a bottom side surface (410b) of the first panel (410) defines the rear panel (130) of the ovenable bag (100) as shown in FIG. 1.

As illustrated in FIG. 6, the ovenable bag (100) includes a plurality of material layers (600). The plurality of material layers (600) include at least a paper layer (610) laminated to a polymer layer (620). The polymer layer (620) defines an inner surface of the bag that forms the interior chamber (125) (see FIG. 3) and an upper baking surface (110a) of the baking sheet (110) when the ovenable bag (100) is opened into the baking sheet (110) (see in FIG. 5). The paper layer (610) defines an outer surface of the ovenable bag (100) and a lower baking surface (110b) of the baking sheet (110) when the ovenable bag (100) is opened into the baking sheet (100).

A peelable adhesive (605) may be applied to an outer perimeter of the polymer layer (620). The peelable adhesive (605) is applied to the polymer layer (620) so that the sealed edge portions (101, 103) and the sealed closure flap (145) are formed when the ovenable bag (100) is formed (see FIG. 1). It is noted that the peelable adhesive (605) may be applied to the polymer layer (620) by a gravure printer and that the ovenable bag (100) may be formed from a reel stock of the plurality of layers (600) using a vertical form fill seal machine (FSS) although other conventional packaging machines may be used to form the ovenable bag (100). The peelable adhesive (605) is also provided so as to ensure that a consumer can readily and easily open the ovenable bag (100) into the baking sheet (110) (see FIG. 3) while simultaneously inhibiting tampering of the ovenable bag (100) prior to a conversion into the baking sheet (110) (for example, while the ovenable bag (100) moves through the supply chain to the consumer's shelf).

The plurality of material layers (600) are constructed in this manner to resist degradation of the bag (and food product) in storage, transport and during a baking operation. The plurality of material layers (600) also improves baking of the food product (for example, reduces cook time, increases crispness). The polymer layer (620) is heat resistant and thus provides strength to the ovenable bag (100) and resists heat generated at typical baking temperatures so as to improve the baking of the food product. The paper layer (610) is heat stable and thus, when laminated with the polymer layer (620), the laminated material layers (600) prevent curling or distortion of the baking sheet (110) during the baking operation.

In addition, it is noted that the paper layer (610) may be a printable virgin fiber paper and the polymer layer (620) may be a nylon. A ratio of the paper layer (610) to the polymer layer (620) may be 3:1 and the plurality of material layers (600) may each have a gauge of 60 μm to 100 μm, but preferably 80 μm. In addition, the plurality of material layers (600) is devoid of any metallic element or microwave susceptor element.

The ovenable blank (400) is also constructed from the plurality of material layers (600) discussed above. Thus, further discussion of the material layers is being omitted herein. However, it is noted that the laminated polymer layer (620) defines the top side surface (401a) of the ovenable blank (400) (see FIG. 4) that forms an upper baking surface (110a) of the baking sheet (110) and an interior chamber (125) (see FIG. 3) of the ovenable bag (100) when the second (420) and third (430) panels are folded over the first panel (410). It is also noted that the paper layer (610) defines the bottom side surface (403) of the ovenable blank (400) (see FIG. 4) that forms a lower baking surface (110b) of the baking sheet (110) and an outer surface of the ovenable bag (100) (see FIG. 1) when the second (420) and third (430) panels are folded over the first panel (410).

According to a third non-limiting embodiment of the present disclosure a method of forming an ovenable bag convertible into a baking sheet for baking a food product is provided. The method includes (S1) forming the ovenable bag (100) from the plurality of material layers (600), (S2) placing the food product in the ovenable bag (100), and (S3) sealing the ovenable bag to secure the food product.

In forming the ovenable bag in (S1)-(S3), the plurality of material layer (600) (see FIG. 6) are manipulated (for example, heated, folded, adhesive coated, sealed) such that the resultant ovenable bag (100) includes the front panel (120), the rear panel (130), and the closure (140) disposed on the front panel (120) (see FIG. 1), as well as the interior chamber (125) defined between the formed front (120) and rear (130) panels (see FIG. 3). The closure (140) is also formed in such a manner to allow the ovenable bag (100) to be opened from the closure (140) into the baking sheet (110) for placement in an oven environment (see FIG. 5).

The formation of the ovenable bag in (S1)-(S3) also includes the formation of the opposing sealed edge portions (101, 103), and the opposing folded edge portions (105,107) extending in a direction generally transverse to the opposing sealed edge portions (101, 103) where the sealed edge portions (101, 103) and the folded edge portions (105, 107) define outer edge portions of the ovenable bag (100) (see FIG. 1). As shown in FIGS. 3 and 5, the ovenable bag (100) is formed such that when the closure (140) is opened, the sealed edge portions (101, 103) separate and the folded edge portions (105, 107) unfold such that the ovenable bag (100) is openable into the baking sheet (110).

### Example

For purposes of enhancing the readers understanding of the present application, the following example is provided to describe an ovenable bag from formation to conversion into a baking sheet for baking a food product thereon. For illustrative, non-limiting purposes, the description of the formation and conversation of the ovenable bag will be described in terms of the features of both the ovenable bag and the ovenable blank discussed above.

Initially, a reel stock of a sheet material including a plurality of material layers is provided. The reel stock of sheet material may be configured as a plurality of ovenable blanks that are to be processed so as to form a plurality of ovenable bags that are convertible into baking sheets. The plurality of material layers include a paper layer laminated to a polymer layer. The reel stock is configured to be fed through a vertical form fill seal machine (FSS) that forms the ovenable bag.

During formation of the ovenable bag, the reel stock is fed through the FFS such that an ovenable blank portion of the reel stock is provided for processing into the ovenable bag. The ovenable blank portion of the reel stock may be processed such that a plurality of panels, fold lines and upper and bottom edge portions are folded and sealed to one another to form the ovenable bag and its closure.

It is noted that the sealing operation may include application of an adhesive to at least some of the panels and upper and bottom edge portions of the blank, and use of at least one of pressure and heat to activate the adhesive to seal together the various portions of the blank during formation. The adhesive may be any commercially available peelable adhesive that is suitable to resist tampering and temperature fluctuations during storage and transportation of the ovenable bag, yet pliant enough to be opened with sufficient force by the consumer for use. It is also noted that during an intermediate step of the ovenable bag formation process, a food product, e.g., potato chips, is dispensed into the partially formed ovenable bag and secured therein when the ovenable bag is completely sealed towards the end of the bag formation.

The formed ovenable bag, including the potato chips, is then separated from the FFS and packaged with other processed ovenable bags containing potato chips for storage and shipment to, e.g., grocery store shelves/freezers for purchase by consumers.

Once purchased, a consumer may use the ovenable bag in the following manner to bake the potato chips. The consumer may place the ovenable bag, e.g., on a flat metal oven pan or any flat food preparation surface. The consumer may then pinch a gripping region of the ovenable bag disposed on opposed sides of the formed closure and pull the opposed sides of the bag with a sufficient pulling force to allow the closure to separate from itself thereby further allowing the ovenable bag to be opened into the baking sheet with the potato chips being spread across an upper baking surface of the newly formed baking sheet. The consumer may further spread the potato chips across the upper baking surface to ensure even baking in an oven environment.

The consumer may then place the baking sheet (loaded with the potato chips), either alone or in combination with the oven pan, in the oven for a baking operation of the potato chips. In this example, the potato chips may be baked in an oven environment at 400° F. for 25-30 minutes. Once the baking operation is complete, the consumer removes the baking sheet from the oven, serves the baked potato chips and throws away (or recycles) the baking sheet for easy and convenient clean-up. Consumers benefit from such an easy clean-up because the timely tasks of, e.g., putting away ingredients and cleaning utensils used during a typical baking operation, are minimized, and because these tasks are minimized the convertible ovenable bag enhances time-savings and food options available to those busy individuals and families needing sustenance but prioritizing their next work, school or social commitment.

In an alternative operation, the ovenable bag may be placed directly into the oven environment without being converted into the baking sheet. In this situation, when the baking operation is complete, the consumer can place the ovenable bag on a flat food preparation surface and pull the bag open with a sufficient pulling force to allow the ovenable bag to be opened into the baking sheet to serve the oven-baked food product. Again, the baking sheet is then simply thrown away (or recycled) for easy and convenient clean-up.

Accordingly, the ovenable bag/blank as discussed in detail above, provides consumers a convenient, time-saving ovenable package for storing and baking a food product. As a result, the convertible ovenable bag/blank enhances time-savings and food options available to busy consumers by simplifying preparation and clean-up for baking the food product and reducing clean-up time.

Although the present disclosure has been described with reference to several exemplary embodiments, which can be combined in any suitable manner, it is understood that the words that have been used are words of description and illustration, rather than words of limitation. Changes may be made within the purview of the appended claims, as presently stated and as amended, without departing from the scope and spirit of the invention in its aspects. Although the present disclosure has been described with reference to particular means, materials and embodiments, the disclosure is not intended to be limited to the particulars disclosed. Rather, the present disclosure extends to all functionally equivalent structures, methods and uses such as are within the scope of the appended claims.

1. An ovenable bag convertible into a baking sheet for baking a food product, comprising:
a front panel;
a rear panel; and
a closure disposed on the front panel,
the front panel and the rear panel defining an interior chamber for holding the food product, and
the closure being configured to allow the ovenable bag to be openable into the baking sheet.

2. The ovenable bag according to claim 1, further comprising:
opposing sealed edge portions; and
opposing folded edge portions extending in a direction generally transverse to the opposing sealed edge portions,
the sealed edge portions and the folded edge portions defining outer edge portions of the ovenable bag, wherein
when the closure is opened, the sealed edge portions separate and the folded edge portions unfold such that the ovenable bag is openable into the baking sheet.

3. The ovenable bag according to claim 2, wherein the closure includes a sealed closure flap that extends along a longitudinal length of the front panel, and
wherein the sealed closure flap and the sealed edge portions are sealed with a peelable adhesive.

4. The ovenable bag according to claim 2, wherein the closure extends in the direction generally transverse to the opposing sealed edge portions along an entire longitudinal length of the front panel.

5. The ovenable bag according to claim 1, further comprising:
a gripping region disposed on the front panel and proximate opposing sides of the closure,
the gripping region being configured to allow external forces acting on the opposing sides of the closure to open the closure and allow the ovenable bag to be openable into the baking sheet.

6. The ovenable bag according to claim 1, the front panel and the rear panel each having a plurality of material layers, wherein
the plurality of material layers include at least a paper layer laminated to a polymer layer,
the polymer layer defining an inner surface of the bag that forms the interior chamber and an upper baking surface of the baking sheet when the ovenable bag is opened into the baking sheet, and
the paper layer defining an outer surface of the ovenable bag and a lower baking surface of the baking sheet when the ovenable bag is opened into the baking sheet.

7. The ovenable bag according to claim 6, wherein the paper layer is a printable virgin fiber paper and the polymer layer is a nylon, and
wherein a thickness ratio of the paper layer to the polymer layer is 3:1.

8. The ovenable bag according to claim 6, wherein the plurality of material layers is devoid of any metallic element or microwave susceptor element.

9. An ovenable blank for forming an ovenable bag that is convertible into a baking sheet for baking a food product, comprising:
a first panel including a first side edge, a second side edge, an upper edge portion and a bottom edge portion;
a second panel including an outer side edge, an inner side edge, an upper edge portion and a bottom edge portion, the inner side edge of the second panel being disposed along the first side edge of the first panel at a first fold line,
a third panel including an outer side edge, inner side edge, an upper edge portion and a bottom edge portion, the inner side edge of the third panel being disposed along the second side edge of the first panel at a second fold line,
a fourth panel including an outer side edge, an inner side edge, an upper edge portion and a bottom edge portion, the inner side edge of the fourth panel being disposed along the outer side edge of the second panel at a third fold line, and
a fifth panel including an outer side edge, inner side edge, an upper edge portion and a bottom edge portion, the inner side edge of the fifth panel being disposed along the outer side edge of the third panel at a fourth fold line,
wherein each of the upper edge portion and the bottom edge portion of at least one of either the first panel, or the second and third panels together, is coated with a peelable adhesive on a top side surface of the blank, and
wherein at least one of the fourth panel and the fifth panel is entirely coated with the peelable adhesive on the top side surface of the blank.

10. The ovenable blank according to claim 9, wherein the upper edge portion and the bottom edge portion of each of the first, second, and third panels are coated with the peelable adhesive on the top side surface of the blank, and
wherein each of the fourth panel and the fifth panel is entirely coated with the peelable adhesive on the top side surface of the blank.

11. The ovenable blank according to claim 9, wherein the second and third panels are configured to fold over the first and second fold lines, respectively, to cover the first panel and to define an interior chamber for holding the food product, and
wherein when the second and third panels are folded over the first panel, the first fold line and the second fold line define folded edge portions of the ovenable bag,
the upper edge portion and the bottom edge portion of each of the second panel and the third panel are adhesively secured to the upper edge portion and the bottom edge portion of the first panel to define sealed edge portions of the ovenable bag, and
the fourth and fifth panels are adhesively secured to one another to define a sealed closure flap disposed on the front panel of the ovenable bag, the sealed closure flap being foldable over one of the third and fourth fold lines in a direction toward one of the second and third panels, respectively.

12. The ovenable blank according to claim 9, wherein top side surfaces of the second and third panels are configured to fold over the first and second fold lines, respectively, to cover a top side surface of first panel to define an interior chamber for holding the food product, and
wherein when the second and third panels are folded over the first panel, bottom side surfaces of the second and third panels define a front panel of the ovenable bag and a bottom side surface of the first panel defines a rear panel of the ovenable bag.

13. The ovenable blank according to claim 9 further comprising:
a plurality of material layers, wherein
the plurality of material layers include at least a paper layer laminated to a polymer layer,
the polymer layer defining the top side surface of the ovenable blank that forms an upper baking surface of the baking sheet and an interior chamber of the ovenable bag when the second and third panels are folded over the first panel, and
the paper layer defining the bottom side surface of the ovenable blank that forms a lower baking surface of the baking sheet and an outer surface of the ovenable bag when the second and third panels are folded over the first panel.

14. The ovenable blank according to claim 13, wherein the paper layer is a printable virgin fiber paper and the polymer layer is a nylon, and
wherein a thickness ratio of the paper layer to the polymer layer is 3:1.

15. The ovenable blank according to claim 13, wherein the plurality of material layers is devoid of any metallic element or microwave susceptor element.

16. A method of forming an ovenable bag convertible into a baking sheet for baking a food product, comprising:
forming the ovenable bag from a plurality of material layers;
placing the food product in the ovenable bag; and
sealing the ovenable bag to secure the food product therein,
the ovenable bag comprising:
a front panel;
a rear panel; and
a closure disposed on the front panel,
wherein the front panel and the rear panel define an interior chamber therebetween that holds the food product, and
wherein the closure is configured to allow the ovenable bag to be opened into the baking sheet for placement in an oven environment.

17. The method according to claim 16, wherein the ovenable bag further comprises:
opposing sealed edge portions; and
opposing folded edge portions extending in a direction generally transverse to the opposing sealed edge portions,
the sealed edge portions and the folded edge portions defining outer edge portions of the ovenable bag, wherein
when the closure is opened, the sealed edge portions separate and the folded edge portions unfold such that the ovenable bag is openable into the baking sheet.

18. The method according to claim 16, wherein the plurality of material layers include at least a paper layer laminated to a polymer layer,
the polymer layer defining an inner surface of the ovenable bag that forms the interior chamber and an upper baking surface of the baking sheet when the ovenable bag is opened into the baking sheet, and
the paper layer defining an outer surface of the ovenable bag and a lower baking surface of the baking sheet when the ovenable bag is opened into the baking sheet.

19. The method according to claim 18, wherein the paper layer is a printable virgin fiber paper and the polymer layer is a nylon, and
wherein a thickness ratio of the paper layer to the polymer layer is 3:1.

20. The method according to claim 18, wherein the plurality of material layers is devoid of any metallic element or microwave susceptor element.
